(19) United States
(12) Patent Application Publication
(10) Pub. No.: US 2004/0226883 A1
(43) Pub. Date: Nov. 18, 2004

(54) Non-woven fabric filter and wastewater treatment with activated sludge process using the non-woven fabric filter

(76) Inventors: Yap-Jung Hu, Hsinchu-City (TW); Wui-Cheng Wu, Yilan City (TW); Ya-Chun Wo, Tainan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/689,418

(22) Filed: Oct. 20, 2003

(30) Foreign Application Priority Data
Oct. 24, 2002 (TW) 91124774

(51) Int. Cl. B01D 29/00

(52) U.S. Cl. 210/631; 210/483

(57) ABSTRACT

A non-woven fabric filter used for wastewater treatment with activated sludge. The present invention, for the first time, uses non-woven fabric as a filtering material for wastewater treatment. The non-woven fabric filter for wastewater treatment includes a tubular non-woven fabric filtering portion, which has a mean pore size of 0.2 μm to 150 μm; a porous tubular supporting portion disposed on inner walls of the tubular non-woven fabric filtering portion to provide support; and a sealing portion for sealing two ends of the tubular non-woven fabric filtering portion and the tubular supporting portion, while leaving a hollow space in the tubular supporting portion.

### BACKGROUND OF THE INVENTION

1. Field of the Invention

The present invention relates to a wastewater treatment apparatus, and more particularly to a wastewater treatment with activated sludge process using a non-woven fabric filter.

2. Description of the Prior Art

Conventionally, wastewater treatment with activated sludge is frequently used to decompose organic material in wastewater. In order to obtain clear treated water, various filtration methods have been used to separate activated sludge from the treated water. For example, in Japanese Publication No. 10-290984, hollow fiber membrane modules are used for microorganism wastewater treatment. Activated sludge is isolated by the hollow fiber membrane modules and the treated wastewater is allowed to pass through the modules and drain, so as to achieve the wastewater discharge standard. However, production cost of the hollow fiber membrane modules is very high, and in turn increases cost for wastewater treatment.

### SUMMARY OF THE INVENTION

An object of the present invention is to solve the above-mentioned problems and provide a wastewater treatment process, which uses non-woven fabric as a filtration and separation material for wastewater treatment to separate activated sludge from the treated water. Compared with the conventional method using hollow fiber membrane modules, cost of the present invention is reduced. In addition, the present invention saves more space than the conventional activated sludge wastewater treatment process.

To achieve the above objects, the present invention provides a non-woven fabric filter that can be used for wastewater treatment with activated sludge process. The non-woven fabric filter of the present invention includes:

a tubular non-woven fabric filtering portion, which has a mean pore size of 0.2 μm to 150 μm;

a porous tubular supporting portion disposed on inner walls of the tubular non-woven fabric filtering portion to support the non-woven fabric filtering portion; and

a sealing portion for sealing two ends of the tubular non-woven fabric filtering portion and the tubular supporting portion, while leaving a hollow space in the tubular supporting portion hollow.

The present invention also provides a non-woven fabric filtering module, which includes a plurality of the above-mentioned non-woven fabric filters.

The present invention also provides a process for fabricating a non-woven fabric filter and the process includes the following steps. First, a tubular non-woven fabric filtering portion is provided. The tubular non-woven fabric filtering portion has a mean pore size of 0.2 μm to 150 μm. Next, a porous tubular supporting portion is disposed on inner walls of the tubular non-woven fabric filtering portion to provide support. Next, two ends of the tubular non-woven fabric filtering portion and the tubular supporting portion are sealed with a sealing portion, while leaving a hollow space in the tubular supporting portion.

The present invention also provides a wastewater treatment process with activated sludge using a non-woven fabric filter and the process includes the following steps. First, a wastewater treatment tank is provided, in which activated sludge and the above-mentioned non-woven fabric filter are contained. Next, wastewater containing organic material is introduced into the wastewater treatment tank, so as to allow activated sludge to decompose organic material in wastewater. Next, the decomposed water is allowed to permeate through the non-woven fabric filter to obtain filtered water.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a perspective view of the non-woven fabric filter for wastewater treatment according to a preferred embodiment of the present invention.

FIG. 2 is a longitudinal cross-section taken along line 2-2′ of FIG. 1.

FIG. 3A is a transversal cross-section taken along line 3A-3A′ of FIG. 1.

FIG. 3B is a transversal cross-section taken along line 3B-3B′ of FIG. 1.

### DETAILED DESCRIPTION OF THE INVENTION

The present invention is novel in that for the first time a non-woven fabric filter is used in wastewater treatment with activated sludge process. The activated sludge wastewater treatment process of the present invention includes the following steps. First, activated sludge is charged in a wastewater treatment tank. The non-woven fabric filter of the present invention is then placed in the tank. Next, wastewater containing organic material is introduced into the wastewater treatment tank, so as to allow activated sludge to decompose the organic material therein. Finally, the decomposed water is permeated through the non-woven fabric filter to obtain filtered water.

The present invention uses a special non-woven fabric filter that includes a non-woven fabric filtering portion. The porous non-woven fabric filtering portion has a mean pore size of 0.2 μm to 150 μm. The present invention uses a filter made of non-woven fabric material to treat wastewater containing organic material. The purpose of the non-woven fabric filter is to separate activated sludge from the treated water.

The non-woven fabric filtering portion used in the present invention can have a planar or a folded shape. According to practical requirements, the non-woven fabric filtering portion with a folded shape, can increase the filtration area.

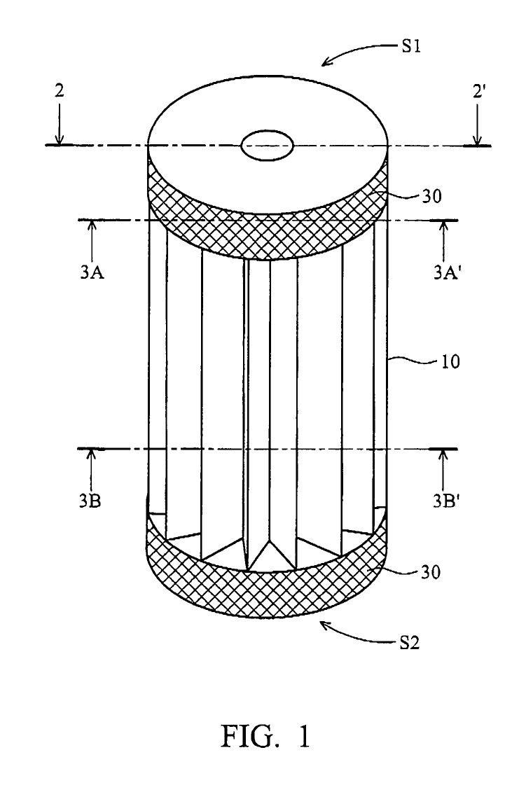

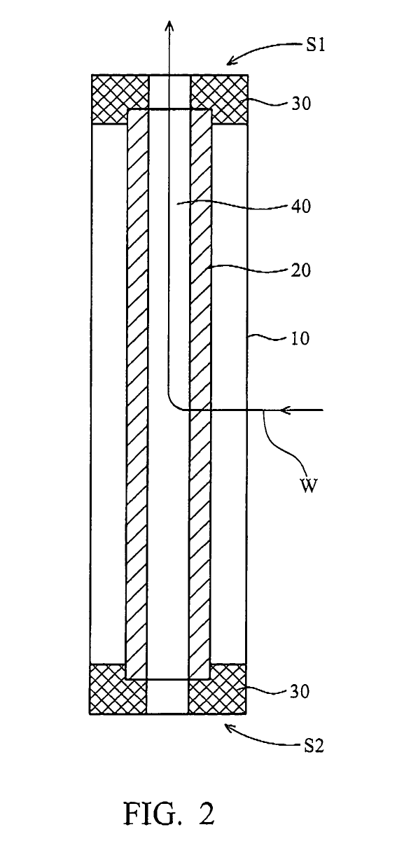

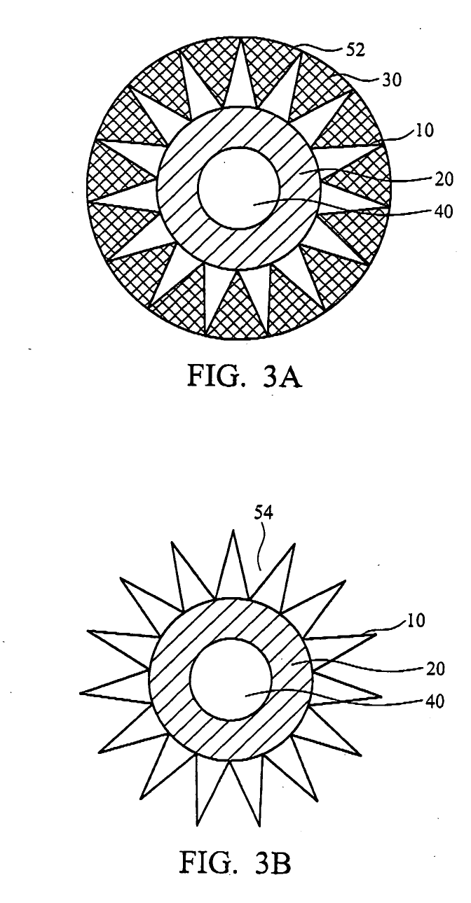

FIGS. 1 to 3 show the non-woven fabric filter for wastewater treatment according to a preferred embodiment of the present invention, in which FIG. 1 is a perspective view, FIG. 2 is a longitudinal cross-section taken along line 2-2′ of FIG. 1, FIG. 3A is a transversal cross-section taken along line 3A-3A′ of FIG. 1, and FIG. 3B is a transversal cross-section taken along line 3B-3B′ of FIG. 1.

Referring to FIGS. 1, 2, 3A and 3B, the non-woven fabric filter, according to the present invention, includes a tubular non-woven fabric filtering portion 10, a tubular supporting portion 20, and a sealing portion 30. The tubular non-woven fabric filtering portion 10 is folded and has a mean pore size of 0.2 μm to 150 μm. The tubular supporting portion 20 is disposed on inner walls of the tubular non-woven fabric filtering portion 10 to provide support. The tubular supporting portion 20 is porous and has a mean pore size of 100 μm to 3 mm, which is larger than the mean pore size of the tubular non-woven fabric filtering portion 10. The sealing portion 30 seals two ends S1 and S2 of the tubular non-woven fabric filtering portion 10 and the tubular supporting portion 20, while leaving a hollow space 40 in the tubular supporting portion 20. The hollow space 40 provides an outlet for permeating the treated water.

As can be seen from FIGS. 1, 2, and 3A, the sealing portion 30 seals in an outer space 52 defined by the folded non-woven fabric filtering portion 10 at two ends S1 and S2 of the tubular non-woven fabric filtering portion 10 and the tubular supporting portion 20. However, referring to FIG. 3B, in the portion other than the two ends S1 and S2, the sealing portion does not fill in an outer space 54 defined by the folded non-woven fabric filtering portion 10.

In order to provide suitable hardness and supporting force to support the folded tubular non-woven fabric filtering portion 10, the tubular supporting portion 20 suitable for use in the present invention can comprise porous non-woven fabric or be a porous plastic tube. The sealing portion 30 suitable for use can be a polymer material.

According to the present invention, the non-woven fabric filter shown in FIG. 1 can be used for wastewater treatment, which is described as follows. First, a plurality of non-woven fabric filters as shown in FIG. 1 is combined to constitute a non-woven fabric filtering module. For example, 50 to 500 non-woven fabric filters are used. Next, activated sludge and the non-woven fabric filtering module are placed in a wastewater treatment tank. Next, organic material-containing wastewater is introduced into the wastewater treatment tank, so as to allow activated sludge to decompose organic material in wastewater. Finally, the treated water permeates through the walls of the tubular non-woven fabric filtering portion 10 and the tubular supporting portion 20 and into the hollow space 40 inside the tubular supporting portion 20, thus obtaining filtered water. Referring to FIG. 2, the treated water permeates through the pathway indicated by arrow W. The activated sludge remains in the tank to continuously decompose organic materials in wastewater.

In conclusion, the present invention, for the first time, uses non-woven fabric in wastewater treatment to separate activated sludge. Water treated by activated sludge permeates through the walls of the tubular non-woven fabric filtering portion 10 and the tubular supporting portion 20 of the wastewater treatment filter, and permeates into the hollow space 40 inside the tubular supporting portion 20, obtaining filtered water. The non-woven fabric can be designed to have a folded shape in order to increase the contact area with the wastewater, thus increasing filtration efficiency. Compared with the conventional process using a hollow fiber membrane, the present invention has reduced cost and saves space.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A non-woven fabric filter for wastewater treatment with activated sludge process comprising:
a tubular non-woven fabric filtering portion, which has a mean pore size of 0.2 μm to 150 μm;
a porous tubular supporting portion disposed on inner walls of the tubular non-woven fabric filtering portion to support the non-woven fabric filtering portion; and
a sealing portion for sealing two ends of the tubular non-woven fabric filtering portion and the tubular supporting portion, while leaving a hollow space in the tubular supporting portion.

2. The non-woven fabric filter as claimed in claim 1, wherein the non-woven fabric filtering portion is planar.

3. The non-woven fabric filter as claimed in claim 1, wherein the non-woven fabric filtering portion is folded.

4. The non-woven fabric filter as claimed in claim 1, wherein the porous tubular supporting portion has a mean pore size of 100 μm to 3 mm.

5. The non-woven fabric filter as claimed in claim 1, wherein the tubular supporting portion is porous non-woven fabric.

6. The non-woven fabric filter as claimed in claim 1, wherein the tubular supporting portion is a porous plastic tube.

7. The non-woven fabric filter as claimed in claim 1, wherein the sealing portion is a polymer material.

8. A non-woven fabric filtering module, comprising a plurality of the non-woven fabric filters as claimed in claim 1.

9. A process for fabricating a non-woven fabric filter, comprising the following steps:
providing a tubular non-woven fabric filtering portion, wherein the tubular non-woven fabric filtering portion has a mean pore size of 0.2 μm to 150 μm;
disposing a porous tubular supporting portion on inner walls of the tubular non-woven fabric filtering portion to support the non-woven fabric filtering portion; and
sealing two ends of the tubular non-woven fabric filtering portion and the tubular supporting portion with a sealing portion, while leaving a hollow space in the tubular supporting portion.

10. A wastewater treatment process with activated sludge process using a non-woven fabric filter, comprising the following steps:
providing a wastewater treatment tank in which activated sludge and the non-woven fabric filter as claimed in claim 1 are contained;
introducing wastewater containing organic material into the wastewater treatment tank, so as to allow activated sludge to decompose organic material in wastewater; and
allowing the decomposed water to permeate through the non-woven fabric filter to obtain filtered water.

11. The wastewater treatment process with activated sludge as claimed in claim 10, wherein the step of allowing the decomposed water to permeate through the non-woven fabric filter includes allowing the decomposed water to permeate through the walls of the tubular non-woven fabric filtering portion and the porous tubular supporting portion and to permeate out from the hollow space in the tubular supporting portion.
